(19) United States
(12) Patent Application Publication
(10) Pub. No.: US 2021/0116627 A1
(43) Pub. Date: Apr. 22, 2021

(54) OPTICAL SHEET AND BACKLIGHT UNIT

(71) Applicant: KEIWA INC., Chuo-ku (JP)

(72) Inventor: Takahiro TSUJI, Chuo-ku (JP)

(73) Assignee: KEIWA INC., Chuo-ku (JP)

(21) Appl. No.: 16/491,971

(22) PCT Filed: Mar. 6, 2018
(86) PCT No.: PCT/JP2018/008453

§ 371 Date: Sep. 6, 2019

(30) Foreign Application Priority Data
Mar. 6, 2017 (JP) 2017-042271

(51) Int. Cl. F21V 8/00; G02B 5/04

(52) U.S. Cl. CPC G02B 6/0053; G02B 6/0058; G02B 6/0055; G02B 5/045

(57) ABSTRACT

An optical sheet includes a plurality of unit prisms disposed in parallel. The unit prism has an elastic modulus within a range of 0.5 MPa to 10 MPa, inclusive, and a height of a ridge of the unit prism that changes in an extending direction of the ridge or differs between unit prisms adjacent to each other. Preferably, the ridge has a linear shape, a polyline shape, or a curved shape, in a planar view. Preferably, a height of the unit prism of the ridge in the extending direction changes within a range of 0.5 μm to 15 μm, inclusive, at an interval within a range of 0.005 mm to 5 mm, inclusive.

### FIELD OF THE INVENTION

The present invention relates to an optical sheet capable of suppressing the occurrence of wet-out between the optical sheet and a light guide plate, and damage to the light guide plate even with extended use, and a backlight unit.

### BACKGROUND ART

A liquid crystal display device, such as a liquid crystal television, includes a liquid crystal panel provided to a front surface side, and a surface light source device (referred to as a backlight unit) provided to a back surface side. The backlight unit is a surface light source provided so as to allow an observer to visually recognize video information displayed by the liquid crystal panel, and is generally configured by a light source, a light guide plate, and an optical sheet. The optical sheet is disposed between the light guide plate and the liquid crystal panel, and includes at least a prism part that deflects a traveling direction of light planarly expanded by the light guide plate to the liquid crystal panel side. The prism part is obtained by arranging unit prisms elongated in one direction in a triangular cross section or a substantially triangular cross section in parallel, is formed on a base material, and constitutes an optical sheet.

The unit prism includes a ridge (also referred to as a ridge part) on an apex part thereof, and constitutes the prism part by arranging a plurality of the unit prisms in a direction orthogonal to the ridge. Optical sheets including such a prism part have a type used with the ridge of the unit prism disposed so as to face the liquid crystal panel side (abbreviated as “normal type optical sheet”), and a type used with the ridge of the unit prism disposed so as to face the light guide plate side (abbreviated as “turning type optical sheet”). While currently optical sheets obtained by layering two normal type optical sheets so that the ridges intersect are frequently adapted, use of a turning type optical sheet in which only one sheet suffices is anticipated with the weight reduction and thinning of small tablet terminals such as smartphones and the weight reduction and thinning of large televisions.

As turning type optical sheets, there have been proposed a sheet in which the ridge shape is devised to suppress the generation of interference fringes (refer to Patent Document 1), a sheet in which the unit prism shape is devised to improve luminance and efficiency (refer to Patent Document 2), a sheet in which the unit prism shape and the constituent resin are devised to reduce damage to the light guide plate (refer to Patent Documents 3 and 4), and the like.

### PATENT DOCUMENTS

Patent Document 1: Japanese Translation of PCT International Application No. 2008-145468
Patent Document 2: WO2004/019082
Patent Document 3: Japanese Laid-Open Patent Application No. 2006-309248
Patent Document 4: Japanese Laid-Open Patent Application No. 2012-150291

### SUMMARY OF THE INVENTION

### Problems to be Solved by the Invention

While, in the turning type optical sheets in Patent Documents 3 and 4, a flat part is provided to a tip of the unit prism or the unit prism is imparted with elasticity in order to reduce damage to the light guide plate, when a flat part is provided to the unit prism or the unit prism is imparted with elasticity, a tip of the unit prism comes into close contact with the light guide plate. Such close contact results in the problem that the phenomenon of so-called wet-out (optical unevenness as if liquid has seeped between the films) readily occurs. While the optical sheets for a liquid crystal display device require an acceleration test defined in JIS standards, wet-out may occur during the acceleration test, particularly in a high temperature environment or a high temperature, high humidity environment.

In addition, recently, since extended use of small tablet terminals such as smartphones and notebook computers has become routine and liquid crystal display devices including a liquid crystal panel tend to be thinner, even when the unit prism tip of the optical sheet and the light guide plate are spaced apart so as to have a predetermined clearance and thus prevent direct contact with each other, the light guide plate may rise or the like due to extended use, causing the light guide plate and the unit prism tip of the turning type optical sheet to readily come into close contact, resulting in the problem that wet-out is more likely to occur. Such problems are not limited to small tablet terminals, and also readily occur in large screen televisions and large screen liquid crystal displays in which the screen is upright.

The present invention has been made to solve the above-described problems, and an object of the present invention is to provide an optical sheet capable of suppressing the occurrence of wet-out between the optical sheet and a light guide plate, and damage to the light guide plate even with extended use, and a backlight unit.

### Means for Solving the Problems

(1) An optical sheet according to the present invention includes a plurality of unit prisms disposed in parallel. The unit prism has an elastic modulus within a range of 0.5 MPa to 10 MPa, inclusive, and a height of a ridge of the unit prism that changes in an extending direction of the ridge or differs between unit prisms adjacent to each other.

According to this invention, the optical sheet includes the unit prism having the elastic modulus within the above-described range, making it possible to keep the unit prism tip from becoming too hard and damaging the light guide plate. In particular, when the optical sheet is installed on the light guide plate to assemble a liquid crystal display device, it is possible to keep the tip of the unit prism from rubbing against and damaging a surface of the light guide plate. Further, the unit prism is the ridge having the above-described form and thus, even when the temperature of the liquid crystal display device rises due to extended use in particular, causing the light guide plate and the tip of the unit prism to readily come into close contact with each other, it is possible to suppress the occurrence of wet-out between the optical sheet and the light guide plate, and damage caused by the rubbing at that time.

In the optical sheet according to the present invention, the ridge has a linear shape, a polyline shape, or a curved shape, in a planar view. According to this invention, the ridge has a linear shape, a polyline shape, or a curved shape in a planar view, making it possible to further suppress the occurrence of wet-out and damage when the temperature of the liquid crystal display device rises due to extended use in particular, causing the light guide plate and the tip of the unit prism to readily come into contact with each other. In particular, preferably the ridge has a polyline shape or a curved shape.

In the optical sheet according to the present invention, a height of the unit prism of the ridge in the extending direction changes within a range of 0.5 μm to 15 μm, inclusive, at an interval within a range of 0.005 mm to 5 mm, inclusive.

In the optical sheet according to the present invention, the unit prism has a recovery rate within a range of 50% to 100%, inclusive.

(2) A backlight unit according to the present invention includes at least the above-described optical sheet according to the present invention, a light guide plate, and a light source. The unit prism constituting the optical sheet is disposed facing a surface of the light guide plate.

According to this invention, it is possible to keep the unit prism tip of the optical sheet according to the present invention from becoming too hard and damaging the light guide plate. In particular, when the optical sheet is installed on the light guide plate to assemble a liquid crystal display device, it is possible to keep the tip of the unit prism from rubbing against and damaging a surface of the light guide plate. Further, even when the temperature of the liquid crystal display device rises due to extended use in particular, causing the light guide plate and the tip of the unit prism to readily come into close contact with each other, it is possible to suppress the occurrence of wet-out between the optical sheet and the light guide plate, and damage caused by the rubbing at that time.

In the backlight unit according to the present invention, the light guide plate is preferably any one selected from an acrylic resin, a polycarbonate resin, and glass.

### Effect of the Invention

According to the present invention, it is possible to suppress the occurrence of wet-out between the optical sheet and a light guide plate, and damage to the light guide plate, even with extended use.

### BRIEF DESCRIPTION OF THE DRAWINGS

FIG. 1 is a schematic configuration drawing illustrating an example of an optical sheet according to the present invention.

FIG. 2 is a configuration drawing of a liquid crystal display device including an example of a backlight unit according to the present invention.

FIG. 3 is a configuration drawing of a liquid crystal display device including another example of the backlight unit according to the present invention.

FIG. 4 is a schematic drawing of wet-out that occurs between the optical sheet and a light guide plate.

FIG. 5 is a schematic drawing illustrating an example of a shape of a ridge of the unit prism.

FIG. 6 is a schematic drawing illustrating another example of the shape of the ridge of the unit prism.

FIG. 7 is a schematic drawing illustrating yet another example of the shape of the ridge of the unit prism.

FIGS. 8A and 8B are schematic configuration drawings illustrating examples of the optical sheet including a light diffusion layer.

FIGS. 9A and 9B are explanatory diagrams of a tip structure of the unit prism.

FIGS. 10A and 10B are images showing the occurrence of wet-out before and after testing.

### EMBODIMENTS OF THE INVENTION

An optical sheet and a backlight unit according to the present invention are described below with reference to the drawings. It should be noted that the present invention allows various modifications as long as the technical characteristics of the present invention are included, and is not limited to the descriptions below or the forms of the drawings.

### [Optical Sheet]

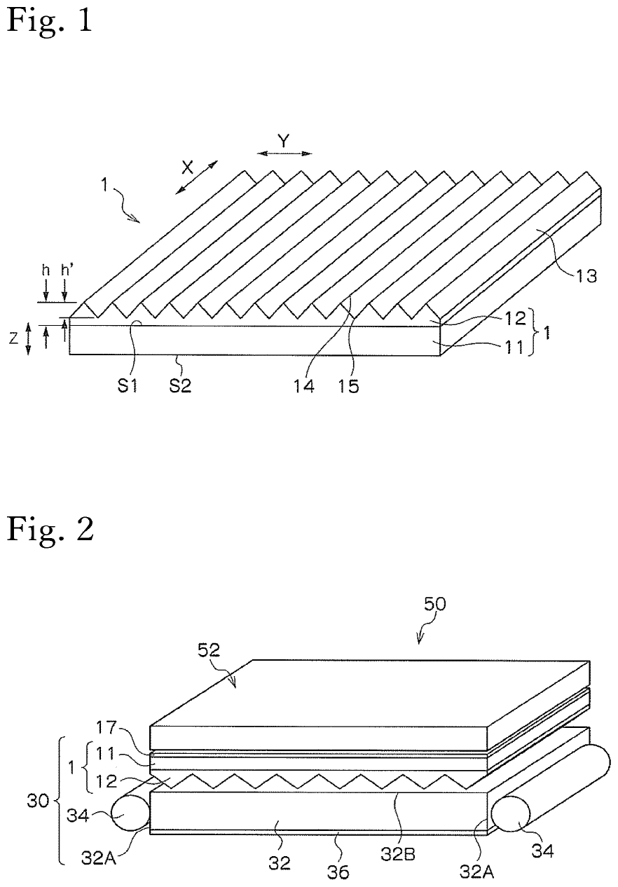

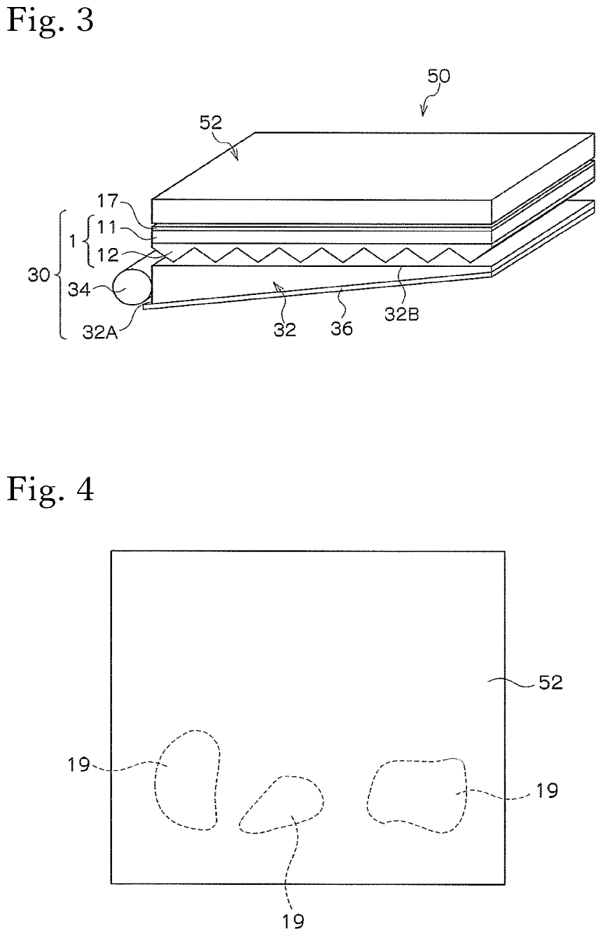

In an optical sheet 1 according to the present invention, a plurality of unit prisms 13 are disposed in parallel as illustrated in FIG. 1 and the like. Then, the unit prism 13 has an elastic modulus within a range of 0.5 MPa to 10 MPa, inclusive, and a height h of a ridge 14 of the unit prism 13 that changes in an extending direction X of the ridge 14 or differs between unit prisms adjacent to each other. The optical sheet 1 is disposed facing a surface of a light guide plate 32 constituting a backlight unit 30, constitutes the light guide plate 32 as well as the backlight unit, and exhibits the effect of making it possible to suppress the occurrence of a wet-out 19 (refer to FIG. 4) that occurs between the optical sheet 1 and the light guide plate 32 even with extended use, and damage to the light guide plate 32, as illustrated in FIG. 2 and FIG. 3. It should be noted that, in the present application, a height h of the ridge 14 of the unit prism 13 refers to a height from a surface S1 of a base material 11, and differs from a height h′ from a trough 15 to the ridge 14.

Hereinafter, each of the components of the optical sheet will be described in detail.

### (Base Material)

The base material 11 is a base material in which a plurality of the unit prisms 13 are provided in parallel, as illustrated in FIG. 1. This base material 11 may be a light transmissive base material capable of transmitting light deflected by the unit prism 13 to a liquid crystal panel 52 side, and preferably has light transmittance within a range in which such a function is not lost. A thickness of the base material 11 is not particularly limited, but normally is within a range of 10 μm to 300 μm, inclusive.

Constituent materials of the base material 11 are not particularly limited as long as the material is a sheet or a film that transmits active energy rays, such as ultraviolet rays or electron rays, for example, and while a flexible glass plate or the like can also be used, a transparent resin sheet or film such as a polyester-based resin, a polycarbonate-based resin, an acrylic resin, a vinyl chloride-based resin, a cycloolefin resin, or a polymethacrylimide-based resin, is preferred. In particular, a material made of polymethyl methacrylate, a mixture of polymethyl acrylate and polyvinylidene fluoride-based resin, polycarbonate-based resin, and a polyester-based resin such as polyethylene terephthalate, having a refractive index higher than that of the unit prism 13 and a low surface reflectance, are preferred. It should be noted that, to improve an adhesion between the unit prism 13 configured by an active energy ray curable composition and the base material 11, the base material 11 may be subjected to an adhesion improvement treatment such as an anchor coating treatment on a surface thereof.

While the method for fabricating the base material 11 is not particularly limited, it is possible to fabricate the base material 11 by single layer extrusion, co-extrusion, coating curing, and other methods. The base material 11 may or may not be stretched, depending on the type. When the base material 11 is stretched, the stretching may be biaxial stretching or uniaxial stretching.

### (Unit Prism)

The unit prism 13 has a triangular cross section or a substantially triangular cross section and is elongated in the one direction X, as illustrated in FIG. 1. Such unit prisms 13 are disposed in parallel on the one surface S1 of the base material 11, and constitute the optical sheet 1. The unit prism 13 includes a ridge part (also referred to as a ridge) 14 on the apex part thereof, and a prism part 12 is configured by arranging a plurality of the unit prisms 13 in a direction Y orthogonal to the ridge part 14. In the unit prism 13, the trough 15 is formed between the unit prisms 13 adjacent to each other. The pitch of the unit prisms 13 adjacent to each other differs according to the specifications of the optical sheet 1 and is not particularly limited as long as within a range satisfying the performance required by the backlight unit 30 for a transmissive display body, but can be selected within a range of 5 μm to 50 μm, inclusive, for example.

The unit prism 13 is configured by a resin cured material, and has an elastic modulus within a predetermined range. In the present invention, preferably the elastic modulus of the unit prism 13 is within a range of 0.5 MPa to 10 MPa, inclusive. The unit prism 13 having an elastic modulus within this range includes a tip, which is the ridge part 14, that is somewhat soft, making it possible to keep the tip from becoming too hard and damaging the light guide plate 32. In particular, when the optical sheet 1 is installed on the light guide plate 32 to assemble the backlight unit 30 and a liquid crystal display device 50, it is possible to keep the tip of the unit prism 13 from rubbing against and damaging the surface of the light guide plate 32. It should be noted that the elastic modulus is a proportional constant between stress and strain in elastic deformation (a physical property value representing difficulty of deformation), and can be measured by a micro indentation hardness tester using a nanoindentation method described in an example described later.

When the elastic modulus of the unit prism 13 is less than 0.5 MPa, the unit prism tip becomes too hard, rubs against the light guide plate 32, and readily damages the surface of the light guide plate 32. On the other hand, when the elastic modulus of the unit prism 13 exceeds 10 MPa, the unit prism tip becomes too soft, comes into close contact with the light guide plate 32, and readily results in the occurrence of the wet-out 19 (refer to FIG. 4). It should be noted that preferably the elastic modulus is within a range of 3 MPa to 8 MPa, inclusive and, with this preferred range, it is possible to, among the effects of the present invention, particularly keep the tip of the unit prism 13 from rubbing against and damaging the surface of the light guide plate 32 when the liquid crystal display device 50 is assembled, to a greater degree.

Furthermore, the elastic modulus may be specified by a recovery rate of the unit prism 13. The preferred recovery rate is within a range of 40% to 100%, inclusive. The recovery rate is a parameter obtained during measurement of the elastic modulus described above and is, for example, a difference [hf/h max] between a depth (indentation depth h max) when a load is applied and a recovery depth hf when the load is removed in a measurement using a nanoindentation tester. The unit prism 13 having a recovery rate within this range becomes a unit prism tip having appropriate elasticity, making it easy to keep the unit prism tip from becoming too hard and damaging the light guide plate 32. When a recovery rate is less than 40%, the unit prism tip has a poor elasticity, becomes too hard, and thus may rub against the light guide plate 32 and readily damage the surface of the light guide plate 32. It should be noted that the preferred range of the recovery rate is within a range of 50% to 80%, inclusive and, with this preferred range, it is possible to, among the effects of the present invention, particularly keep the tip of the unit prism 13 from rubbing against and damaging the surface of the light guide plate 32 when the liquid crystal display device 50 is assembled, to a greater degree.

Examples of preferable constituent resins of the unit prism 13 include an active energy ray curable composition which can be cured by active energy rays such as ultraviolet rays and electron rays and is generally used as a constituent resin for an optical sheet. Examples of such active energy ray curable compositions generally include polyester, (meth)acrylate, epoxy (meth)acrylate, urethane (meth)acrylate, and the like. Among these, as monomers that are cured by heat or active energy rays and used for applications such as paints, there are monomers including a (meth)acryloyl group (acryloyl group or methacryloyl group) in molecules, such as urethane (meth)acrylate, polyester (meth)acrylate, and epoxy (meth)acrylate.

In the optical sheet 1 according to the present invention, the constituent resin of the unit prism 13 need only be a resin composition adjusted so that the elastic modulus of the unit prism 13 is within the range of 0.5 MPa to 10 MPa, inclusive. Examples of preferable resin compositions include a resin composition in which a radical photopolymerization initiator is added to a mixed resin of urethane (meth)acrylate and monofunctional acrylate. Examples of preferable urethane (meth)acrylates include a urethane (meth)acrylate compound containing at least one type of urethane (meth)acrylate compound including two or more (meth)acryloyl groups in a molecule. These compounds can be obtained by reacting a polyisocyanate compound including two or more isocyanate groups in a molecule with one or more types of (meth)acryloyl compounds including one or more (meth)acryloyl groups in a molecule and a hydroxyl group.

Urethane (meth)acrylate can be obtained by reacting (a) polyol, (b) polyisocyanate, and (c) (meth)acrylate including a hydroxyl group in a molecule by a known method as described below. Further, a commercial product described later may also be used.

While the polyol of (a) is not particularly limited, specifically polyester polyol, polycarbonate polyol, polyether polyol, aliphatic hydrocarbon-based polyol, and alicyclic hydrocarbon-based polyol can be used. Among these polyols, bisphenol A, bisphenol F, bisphenol S, and alkylene oxide modified products thereof are preferred.

While the polyisocyanate of (b) is also not particularly limited, specific examples include aliphatic polyisocyanate, alicyclic polyisocyanate, aromatic polyisocyanate, and araliphatic polyisocyanate. Examples of aliphatic polyisocyanates include tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, 3-methylpentane-1,5-diisocyanate, and the like. Examples of alicyclic polyisocyanates include isophorone diisocyanate, hydrogenated xylylene diisocyanate, 4,4′-dicyclohexylmethane diisocyanate, 1,4-cyclohexane diisocyanate, methylcyclohexylene diisocyanate, 1,3-bis(isocyanatemethyl)cyclohexane, and the like. Examples of aromatic polyisocyanates include tolylene diisocyanate, 2,2′-diphenylmethane diisocyanate, 2,4′-diphenylmethane diisocyanate, 4,4′-diphenylmethane diisocyanate (MDI), 4,4′-dibenzyl diisocyanate, 1,5-naphthylene diisocyanate, xylylene diisocyanate, 1,3-phenylene diisocyanate, 1,4-phenylene diisocyanate, and the like. Examples of araliphatic polyisocyanates include dialkyl diphenylmethane diisocyanate, tetraalkyl diphenylmethane diisocyanate, α,α,α,α-tetramethyl xylylene diisocyanate, and the like. These can also be used singly or in combination of two or more. From the viewpoint of lowering viscosity, hexamethylene diisocyanate is preferred, and from the viewpoint of the refractive index, the use of tolylene diisocyanate or xylylene diisocyanate is preferred.

While the (meth)acrylate including a hydroxyl group in the molecule of (c) is also not particularly limited, specific examples include 2-hydroxyethyl acrylate, 2-hydroxyethyl methacrylate, 2-hydroxypropyl acrylate, 2-hydroxypropyl methacrylate, 4-hydroxybutyl acrylate, caprolactone modified-2-hydroxyethyl acrylate, polyethylene glycol mono(meth)acrylate, polypropylene glycol monoacrylate, polybutylene glycol mono(meth)acrylate, 2-(meth)acryloyloxyethyl-2-hydroxyethyl phthalate, phenyl glycidyl ether (meth)acrylate, pentaerythritol triacrylate, dipentaerythritol pentaacrylate, caprolactone modified dipentaerythritol penta(meth)acrylate, and the like, and these can be used singly or in combination of a plurality.

Commercially available examples of urethane (meth)acrylates include AH-600 (non-yellowing type, number of acryloyl groups: 2, molecular weight: about 600), AI-600 (non-yellowing type, number of acryloyl groups: 2, molecular weight: about 600), UA-101H (non-yellowing type, number of methacryloyl groups: 4, molecular weight: about 600), UA-101I (non-yellowing type, number of methacryloyl groups: 4, molecular weight: about 700), UA-306H (non-yellowing type, number of acryloyl groups: 6, molecular weight: about 700), UA-306I (non-yellowing type, number of acryloyl groups: 6, molecular weight: about 800), UA-306T (non-yellowing type, number of acryloyl groups: 6, molecular weight: about 800), and the like, as a urethane (meth)acrylate monomer manufactured by Kyoeisha Chemical Co., Ltd. Further, examples of urethane (meth)acrylate monomers manufactured by Shin-Nakamura Chemical Co., Ltd. include NK Oligo U-4HA (non-yellowing type, number of acryloyl group: 4, molecular weight: about 600), NK Oligo U-4H (non-yellowing type, number of methacryloyl groups: 4, molecular weight: about 600), NK Oligo U-6HA (non-yellowing type, number of acryloyl groups: 6, molecular weight: about 1,000), NK Oligo U-6H (non-yellowing type, number of methacryloyl groups: 6, molecular weight: about 1,000), NK Oligo U-108A (non-yellowing type, number of acryloyl group: 2, molecular weight: about 1,600), NK Oligo U-122A (non-yellowing type, number of acryloyl groups: 2, molecular weight: about 1,100), NK Oligo U-2PPA (non-yellowing type, number of acryloyl groups: 2, molecular weight: about 500), NK Oligo UA-5201 (non-yellowing type, number of alkyl group: 2, molecular weight: about 1,000), NK Oligo UA-1101H (number of acryloyl groups: 6, molecular weight: about 1,800), NK Oligo UA-6LPA (number of acryloyl groups: about 6, molecular weight: about 800), NK Oligo UA-412A (number of acryloyl groups: 2, molecular weight: about 4,700), NK Oligo UA-4200 (number of acryloyl groups: 2, molecular weight: about 1,300), NK Oligo UA-4400 (number of acryloyl groups: 2, molecular weight: about 1,300), and the like. In addition, examples of urethane (meth)acrylate monomers manufactured by Daicel-Cytec Ltd. include Ebecryl 270 (non-yellowing type, number of acryloyl groups: 2, molecular weight: about 1,500), Ebecryl 210 (number of acryloyl groups: 2, molecular weight: about 1,500), Ebecryl 1290K (non-yellowing type, number of acryloyl groups: 6, molecular weight: about 1,000), Ebecryl 5129 (non-yellowing type, number of acryloyl groups: 6, molecular weight: about 800), Ebecryl 4858 (non-yellowing type, number of acryloyl groups: 2, molecular weight: about 600), Ebecryl 8210 (non-yellowing type, number of acryloyl groups: 4, molecular weight: about 600), Ebecryl 8402 (non-yellowing type, number of acryloyl groups: 2, molecular weight: about 1,000), Ebecryl 9270 (non-yellowing type, number of acryloyl groups: 2, molecular weight: about 1,000), Ebecryl 230 (non-yellowing type, number of acryloyl groups: 2, molecular weight: about 5,000), Ebecryl 8201 (non-yellowing type, number of acryloyl groups: 3, molecular weight: about 2,100), Ebecryl 8804 (non-yellowing type, number of acryloyl groups: 2, molecular weight: about 1,300), and the like.

Examples of monofunctional acrylates include ethyl methacrylate, n-butyl methacrylate, isobutyl methacrylate, and the like, and, for example, include Light Ester E, Light Ester NB, Light Ester IB, and the like manufactured by Kyoeisha Chemical Co., Ltd.

In the present invention, a mixing ratio of urethane (meth)acrylate and monofunctional acrylate is adjusted as desired in accordance with the type of urethane (meth)acrylate and the type of monofunctional acrylate so that the elastic modulus of the unit prism 13 is within the range of 0.5 MPa to 10 MPa, inclusive. As an example, as described in an example described later, the unit prism 13 having an elastic modulus within the above-described range is obtained as a mixed resin in which pentaerythritol triacrylate hexamethylene diisocyanate urethane prepolymer and ethyl methacrylate are mixed at a ratio of 6:4. It should be noted that the mixing ratio is as desired in accordance with the type of urethane (meth)acrylate and the type of monofunctional acrylate.

A radical photopolymerization initiator is a compound that generates free radicals upon irradiation of active energy rays such as ultraviolet rays and visible rays to initiate radical polymerization of an ethylenically unsaturated compound, and any compound conventionally known as a photo-radical polymerization initiator can be selected and used. Specific examples include benzoin, benzoin monomethyl ether, benzoin monoethyl ether, benzoin isopropyl ether, acetoin, acetophenone, benzyl, benzophenone, p-methoxybenzophenone, diethoxyacetophenone, 2,2-dimethoxy-1,2-diphenylethane-1-one, α-hydroxyalkylphenone, 2,2-diethoxyacetophenone, 1-hydroxycyclohexyl phenyl ketone, methylphenylglyoxylate, ethylphenylglyoxylate, 2-hydroxy-2-methyl-1-phenylpropane-1-one, 2-methyl-1-[4-(methylthio)phenyl]-2-morpholinopropanone-1-one, 2-benzyl-2-dimethylamino-1-(4-morpholinophenyl) butanone-1, tetramethylthiuram monosulfide, tetramethylthiuram disulfide, 2,4,6-trimethylbenzoyldiphenylphosphine oxide, bis(2,6-di methoxybenzoyl)-2,4,4-trimethylpentylphosphine oxide, bis(2,4,6-trimethylbenzoyl)phenylphosphine oxide, camphor quinone, and the like.

It should be noted that, as a resin composition, other arbitrary components may be mixed within a range that does not change the gist of the present invention. For example, photoinitiators such as a benzophenone base, a benzoin base, a thioxanthone base, and a phosphine oxide base may be included. Further, as necessary, silicone, an antioxidant, a polymerization inhibitor, a releasing agent, an antistatic agent, an ultraviolet absorber, a photostabilizer, an antifoaming agent, a solvent, a non-reactive acrylic resin, a non-reactive urethane resin, a non-reactive polyester resin, pigments, dyes, a light diffusing agent, and the like can also be used in combination.

While the method for fabricating the unit prism is not particularly limited, a resin plate made from the above-described resin composition may be formed by heat pressing using a mold member having a desired surface structure, or may be shaped at the same time when the unit prism sheet is manufactured by extrusion molding, injection molding, or the like. Further, the shape may be transferred by a lens mold using a heat- or photo-curable resin or the like, and a method for forming the unit prism using an active energy ray curable composition on at least one surface of the base material 11 is preferred.

Specific examples of the methods include pouring an active energy ray curable composition into a lens mold having a predetermined unit prism pattern formed thereon, layering the base material 11, irradiating active energy rays through the base material 11, polymerizing and curing the active energy ray curable composition, and subsequently peeling the composition from the lens mold to obtain an optical sheet. The lens mold can be selected and used as desired from a mold made from a metal such as aluminum, brass, or steel, a mold made from a synthetic resin such as a silicone resin, a urethane resin, an epoxy resin, an acrylonitrile butadiene styrene (ABS) resin, a fluororesin, or a polymethylpentene resin, and a mold plated with these materials and fabricated by a material obtained by mixing various metal powders, for example. Examples of light sources of the active energy rays to be irradiated include a chemical lamp, a low pressure mercury lamp, a high pressure mercury lamp, a metal halide lamp, an electrodeless ultraviolet (UV) lamp, a visible light halogen lamp, a xenon lamp, and the like, and the light is irradiated at any irradiation intensity.

### (Structure of Unit Prism)

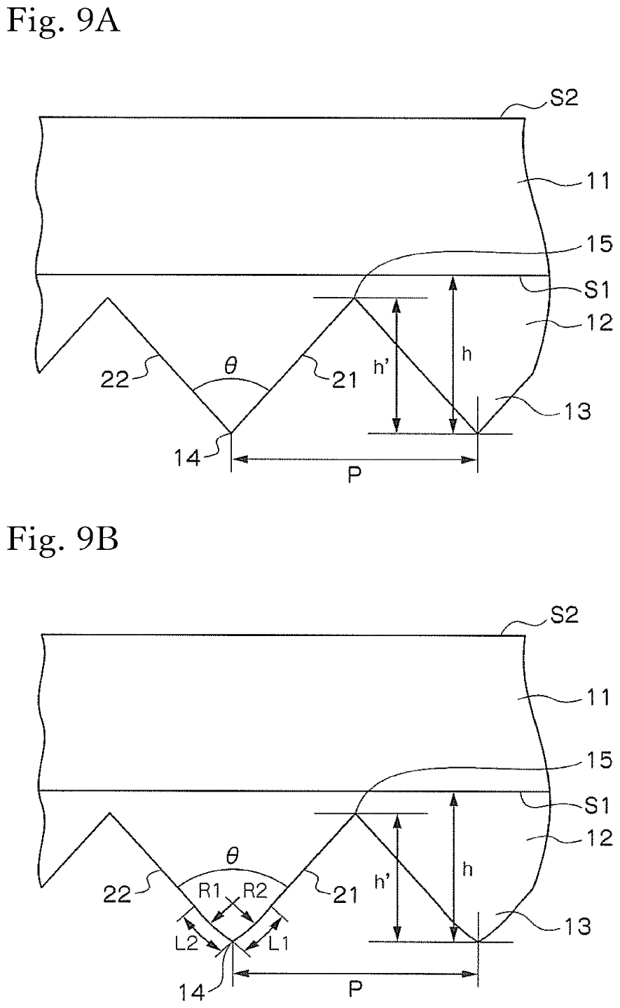

The unit prism 13, as illustrated in FIG. 1 and FIGS. 9A and 9B, has a polygonal cross section in a direction Y orthogonal to the extending direction X of the ridge 14. The polygonal shape is not particularly limited as long as the shape is such that one apex thereof constitutes the ridge 14 of the unit prism 13, and examples include a triangular shape, a quadrilateral shape, a pentagonal shape, a hexagonal shape, a heptagonal shape, and the like. Among these, a triangular shape or a substantially triangular shape such as illustrated in FIG. 1 and FIGS. 9A and 9B is preferred from the viewpoints of easy formation and a superior optical control function.

The optical sheet 1 according to the present invention is preferably applied as a turning type optical sheet disposed facing a surface of the light guide plate 32, and therefore an interior angle θ of the apex constituting the ridge 14 of the unit prism 13 is preferably within a range of 30° to 80°, inclusive, and more preferably within a range of 50° to 70°, inclusive. With the interior angle θ within this range, favorable light deflection can be achieved when the unit prisms 13 are disposed on the light guide plate 32 side as a turning type optical sheet 1. It should be noted that the height h of the unit prism 13 is a distance from the surface S1 (boundary surface) of the base material 11 on which the unit prism 13 is formed to the ridge 14. The reason for setting the height h to the height from the surface S1 of the base material 11 is that the base material surface is disposed parallel with the light guide plate 32.

When the optical sheet 1 is combined with a large liquid crystal panel, a height within a range of 1 μm to 50 μm, inclusive, is preferred, and when the optical sheet 1 is combined with a small liquid crystal panel, a height within a range of 0.5 μm to 30 μm, inclusive, is preferred. It should be noted that, because the unit prism 13 normally has the triangular cross section or the substantially triangular cross section illustrated in FIG. 1 and FIGS. 9A and 9B and an interior angle θ within the above-described range, a pitch (interval) P of the unit prisms 13 is also easily set by the height h and the interior angle θ.

The unit prism 13 having a triangular cross section or a substantially triangular cross section is configured by the two prism surfaces 21, 22, as illustrated in FIGS. 9A and 9B. The prism surfaces 21, 22 may have a linear shape in which the entire surface is a plane (refer to FIG. 9A), or a curved shape in which the entire surface is a curved surface (not illustrated). Further, as illustrated in FIG. 9B, only a tip portion of the unit prism 13 may include curved surface shaped regions L1, L2. Further, when curved surface shaped regions L1, L2 such as illustrated in FIG. 9B, exist, the curved surfaces may have radii of curvature R1, R2 of 30 μm to 200 μm, inclusive.

In the unit prism 13, (i) the height h of the ridge 14 changes in an extending direction of the ridge 14, or (ii) the height h of the ridge 14 differs between unit prisms 13, 13 adjacent to each other. With the ridge 14 having these shapes, the number of positions where the ridge 14 comes into contact with the light guide plate 32 decreases and thus, even when the temperature of the liquid crystal display device rises due to extended use in particular, causing the light guide plate 32 and the tip of the unit prism 13 to readily come into close contact with each other, it is possible to suppress the occurrence of the wet-out 19 between the optical sheet 1 and the light guide plate 32, and damage caused by the rubbing at that time.

When the height h of the ridge 14 of (i) changes in the extending direction of the ridge 14, the height h changes in one or two or more ridge shapes of a linear shape, a stepped shape, a non-linear shape, and a curved shape. A “change in a linear shape” means that the height h is increased or decreased in a single straight line, a “change in a stepped shape” means that the height h is increased and decreased in two or more straight lines, a “change in a non-linear shape” means that the height h is increased and decreased in a combination of straight lines and curved lines, and a “change in a curved shape” means that the height h is increased and decreased in one or a plurality of curved lines. These ridge shapes may be singular or a combination of two or more ridge shapes.

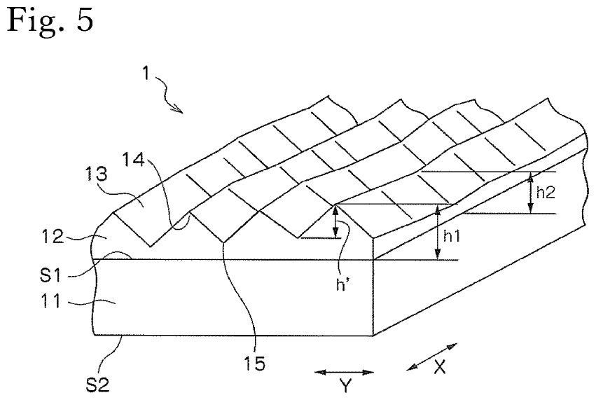

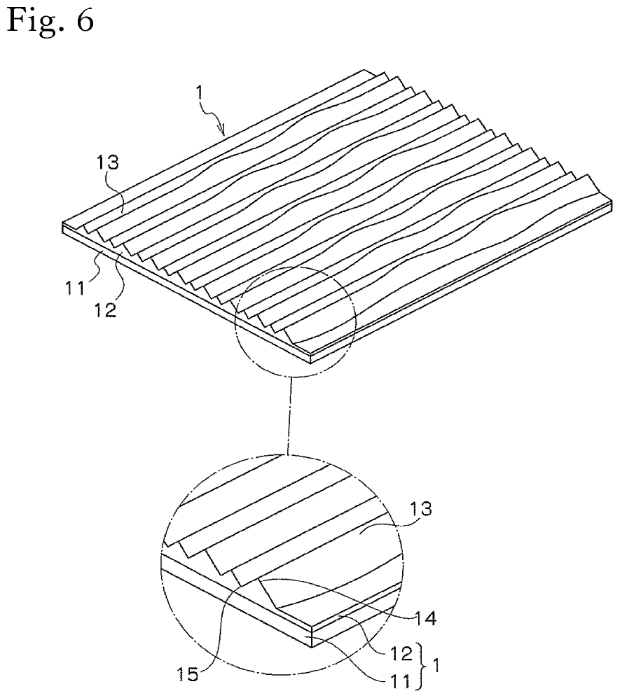

In the example of FIG. 5, the ridge height h of the unit prism 13 changes in a longitudinal direction X of each unit prism 13. For example, the ridge 14 changing within a range of a maximum height h1 to a minimum height h2 of the unit prism 13 in the longitudinal direction X may be uneven in a continuous gentle curved shape or uneven in a polyline shape.

The height h of the ridge 14 in the extending direction X preferably changes within a range of 0.5 μm to 15 μm, inclusive, at the interval P within a range of 0.005 mm to 5 mm, inclusive. The height h is preferably within a range of 0.5 μm to 100 μm, inclusive, but the height in the case of combination with a large liquid crystal panel is more preferably within a range of 1 μm to 50 μm, inclusive, and the height in the case of combination with a small liquid crystal panel is more preferably within a range of 0.5 μm to 30 μm, inclusive. Further, while the interval P (pitch) at which the height h is periodically changed is preferably within the range of 0.005 mm to 5 mm, inclusive, the interval P is slightly adjusted to a preferred range within that range in accordance with a wet-out 19 generation test. The preferred interval P is within a range of 0.01 mm to 3 mm, inclusive.

When the height h of the ridge 14 of (ii) differs between unit prisms 13, 13 adjacent to each other, the height h of the ridge 14 in the extending direction X is constant as illustrated in FIG. 6, and the height h of the ridge 14 of the unit prisms 13, 13 adjacent to each other regularly or irregularly changes. The heights of the ridges of unit prisms adjacent to each other differ from each other, and while not particularly limited, the difference can be, for example, within a range of 2 μm to 10 μm, inclusive.

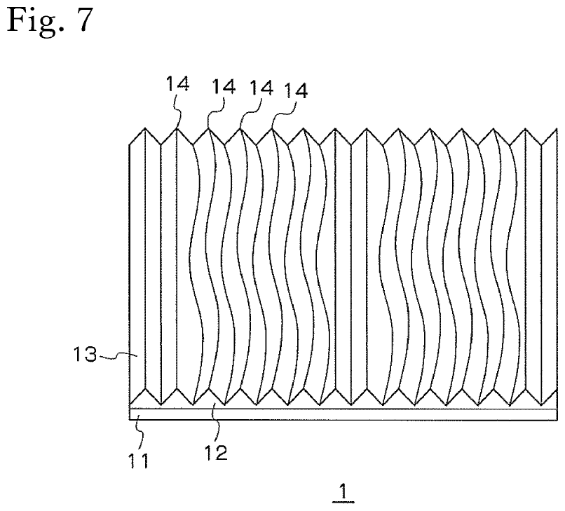

The form illustrated in FIG. 7 is a case where the ridge 14 has a polyline shape or a curved shape in a planar view, in the case of the above-described (i) or (ii). It should be noted that the ridge 14 is as already illustrated in FIG. 5 and FIG. 6 when having a linear shape in a planar view. By setting the ridge to a polyline shape or a curved shape in a planar view, it is possible to further suppress the occurrence of the wet-out 19 and damage when the temperature of the liquid crystal display device 50 rises due to extended use in particular, causing the light guide plate 32 and the tip of the unit prism 13 to readily come into close contact with each other. It should be noted that preferably a bending width of the polyline shape or a bending width W of the curved shape is within a range of 2 μm to 15 μm, inclusive. By setting the width W within this range, the effect can be exhibited.

### (Other)

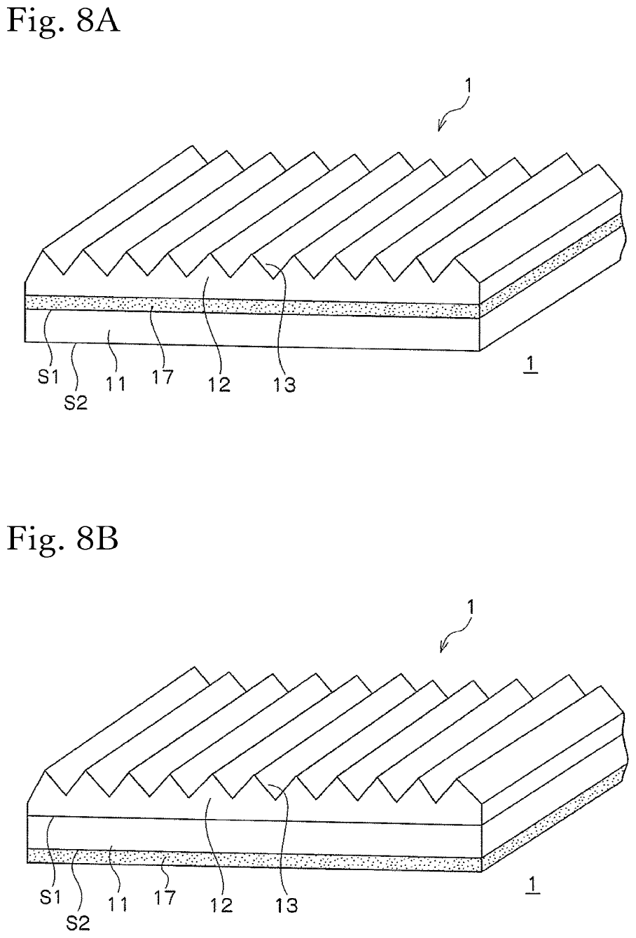

The optical sheet 1 can be imparted with a function of transmitting and diffusing light (referred to as a light transmitting and diffusing function). The means for imparting this light transmitting and diffusing function is not particularly limited, and examples include various conventionally known means. For example, at least one surface (S1 or S2) of the base material 11 constituting the optical sheet 1 can be provided with a light transmission and diffusion layer, or subjected to a so-called matting treatment to have an irregular shape. FIG. 8A is an example in which a light transmission and diffusion layer 17 is provided between the base material 11 and the unit prism 13, and FIG. 8B is an example in which the light transmission and diffusion layer 17 is provided on the surface S2 of the base material 11. The present invention, however, is not limited thereto. The light transmission and diffusion layer 17 need only have a function of transmitting and diffusing light, and examples include a general light transmission and diffusion layer in which a light diffusing material of light diffusible fine particles or the like is dispersed in a transmissive resin. The light transmission and diffusion layer 17 may be provided on both the other surface S2 of the base material 11 and between the one surface S1 of the base material 11 and the unit prism 13. Further, the light diffusing material may be included in the base material 11 and the base material itself may be used as the light transmissive diffusion layer.

As transmissive resin materials constituting the light transmission and diffusion layer, the same resin material as the base material 11 described above, for example, a transparent material such as acrylic, polystyrene, polyester, or vinyl polymer, is used. Furthermore, in the light transmission and diffusion layer, a light diffusing material of light diffusible fine particles or the like is uniformly dispersed. As the light diffusing material, light diffusible fine particles generally used for an optical sheet, for example, polymethyl methacrylate-based (acrylic) beads, polybutyl methacrylate-based beads, polycarbonate-based beads, polyurethane-based beads, nylon beads, calcium carbonate-based beads, silica-based beads, silicone resin beads, and the like, are used.

The light transmission and diffusion layer can be fabricated using various methods. For example, a paint in which a light diffusing material is dispersed in a transmissive binder resin may be formed by coating with spray coating, roll coating, or the like, or a resin material in which a light diffusing material is dispersed may be prepared and formed by co-extrusion with an extruded material of the base material 11. It should be noted that a thickness of the light transmission and diffusion layer is normally within a range of 0.5 mm to 20 μm, inclusive.

Further, although not illustrated, instead of providing the light transmission and diffusion layer 17 on the other surface S2 of the base material 11, the matting treatment, for example, gives the surface S2 a predetermined surface roughness, imparting the surface S2 with a light diffusing function. Examples of means include a method for mechanically roughening the surface by sandblasting or the like, a method for forming an uneven layer including particles, and the like. Further, when the light diffusing material is included in the base material 11, the base material 11 may be manufactured using a resin composition for a base material containing the light diffusing material. In addition, various films such as a reflection type polarizing film and a microlens film may be laminated as desired on the surface S2 of the base material 11 in accordance with the purpose thereof

### [Backlight Unit]

The backlight unit 30 illustrated in FIG. 2 and FIG. 3 is a so-called edge light type backlight unit, and includes the light guide plate 32 that emits light introduced from at least one side end surface 32A from a light emitting surface 32B, which is one surface, a light source 34 for entering light from at least the one side end surface 32A of the light guide plate 32 to the interior, and the optical sheet 1 according to the above-described present invention and provided on the light emitting surface 32B of the light guide plate 32 to transmit light emitted from the light emitting surface 32B. In this optical sheet 1, the unit prisms 13 are disposed facing the surface of the light guide plate 32. It should be noted that FIG. 2 shows the double lamp type backlight unit with the light source 34 on both end surfaces, and FIG. 3 shows the single lamp type backlight unit with one light source 34.

The light guide plate 32 is a plate-like body made from a transmissive material, and is configured to emit the light introduced from the side end surfaces 32A, 32A on both sides in FIG. 2 and the side end surface 32A on the left side in FIG. 3 from the light emitting surface 32B on the upper side. The light guide plate 32 is formed by a transmissive material similar to the material of the optical sheet 1, and normally may be configured by any material selected from an acrylic resin, a polycarbonate resin, and glass, and imparted with a specific shape (for example, a light diffused shape or the like) by a light curing resin on the surface of such an acrylic resin and a polycarbonate resin. A thickness of the light guide plate 32 is not particularly limited, but a thickness of about 0.2 mm to 0.7 mm, inclusive, is generally used at present. A thickness of the light guide plate 32 may be constant across the entire range thereof as illustrated in FIG. 2, or may have a tapered shape thickest at the position of the side end surface 32A on the light source 34 side and gradually thinning in the opposite direction as illustrated in FIG. 3. Preferably, such a light guide plate 32 has a light scattering function added to the interior or the surface in order to emit light from a wide surface (the light emitting surface 32B).

The light source 34 causes light to enter from the side end surfaces 32A, 32A on both sides or the side end surface 32A on one side of the light guide plate 32 to the interior, and is disposed along the side end surface 32A of the light guide plate 32. The light source 34 is not limited to a linear light source such as a fluorescent tube (fluorescent light), and a point light source such as an incandescent lamp or an light emitting diode (LED) may be linearly disposed along the side end surface 32A. Further, a plurality of small flat fluorescent lamps may be disposed along the side end surface 32A.

The light emitting surface 32B of the light guide plate 32 is provided with the optical sheet 1 according to the present invention mentioned above. In the optical sheet 1, the side of the unit prism 13 is provided so as to be the light emitting surface 32B of the light guide plate 32. It should be noted that the details of the optical sheet 1 have already been described and thus will be omitted here.

A reflector 36 is provided on the surface of the light guide plate 32 opposite to the light emitting surface 32B, as illustrated in FIG. 2 and FIG. 3. Further, in the mode illustrated in FIG. 3, the reflector 36 is provided on the surface of the light guide plate 32 opposite to the light emitting surface 32B, and on a side end surface other than the side end surface 32A on the left side. The reflector 36 is configured to reflect light back into the light guide plate 32. As the reflector 36, a thin metal plate with aluminum or the like vapor-deposited, a composite film obtained by vapor-depositing silver on a polyester film, a reflection film having a multilayer structure, white polyethylene terephthalate (PET) foam, or the like, is used.

In the backlight unit illustrated in FIG. 2 and FIG. 3, although the light source 34 having a linear shape, the light source 34 linearly disposed in one direction, or the like, is used, the extending direction of the light source 34 and the extending direction of the ridge 14 of the unit prism 13 of the optical sheet 1 according to the present invention are disposed in parallel.

It should be noted that FIG. 2 and FIG. 3 show the liquid crystal display device 50 obtained by combining the backlight unit 30 and the liquid crystal panel 52, which is a planar transmissive display body, as well. The backlight unit 30 according to the above-described present invention is disposed on a back surface of the liquid crystal panel 52, and irradiates the liquid crystal panel 52 with light from the back surface.

As described above, because the backlight unit 20 according to the present invention includes the optical sheet 1 according to the above-described present invention, it is possible to keep the unit prism tip of the optical sheet 1 from becoming too hard and damaging the light guide plate. In particular, when the optical sheet 1 is installed on the light guide plate to assemble the liquid crystal display device, it is possible to keep the tip of the unit prism 13 from rubbing against and damaging the surface of the light guide plate 32. Further, even when the temperature of the liquid crystal display device rises due to extended use in particular, causing the light guide plate and the tip of the unit prism 13 to readily come into close contact with each other, it is possible to suppress the occurrence of wet-out 19 between the optical sheet 1 and the light guide plate 32, and damage caused by the rubbing at that time.

### EXAMPLES

Hereinafter, the present invention will be specifically described with reference to examples. The present invention is not limited by these descriptions.

### Example 1

### (Fabrication of Optical Sheet)

A 100 μm-thick PET film (Cosmoshine A4100 manufactured by Toyobo Co., Ltd.) was used as a base material. A unit prism mold was prepared by cutting a groove with a numerical control (NC) lathe using a diamond bit so as to have an inverted shape of a linear array of unit prisms having an interior angle θ of 65° on a metal matrix surface. As the resin composition for the unit prism, a resin composition including a mixed resin obtained by mixing pentaerythritol triacrylate hexamethylene diisocyanate/urethane prepolymer (manufactured by Kyoeisha Chemical Co., Ltd.) and ethyl methacrylate (manufactured by Kyoeisha Chemical Co., Ltd.) at a ratio of 6:4, and a photoinitiator (Irgacure 184, α-hydroxyalkylphenone, manufactured by BASF SE) was prepared. The resin composition for the unit prism was poured into the unit prism mold, the above-described base material was layered thereon, the entire base material surface was pressure-bonded to the resin composition with a laminator, and then ultraviolet rays were irradiated on the resin composition from the PET base material surface side to cure the resin composition. Once cured, the resin composition was peeled from the unit prism mold to obtain an optical sheet with unit prisms formed on the base material.

The obtained optical sheet 1 included a plurality of unit prisms having a refractive index of 1.51 to 1.53 and a cross-sectional shape of a main cutting section that was an isosceles triangle. In the unit prism, the arrangement interval P was 37 μm, the height h was 30 μm, the interior angle θ of the apex constituting the ridge 14 was 65.03°, and the length of each side constituting the isosceles triangle was 35.00 μm and 35.03 μm, respectively. It should be noted that the ridge shape of the arranged unit prisms 13 was such that the difference between the maximum height h1 and the minimum height h2 in the extending direction X of the ridge 14 was 4 μm, and this was repeated at a pitch (interval) of 1 mm.

### (Fabrication of Light Guide Plate and Backlight Unit)

The light guide plate 32 was obtained by extrusion molding using a resin composition made of a polycarbonate resin. The obtained light guide plate 32 had a thickness of 550 μm, and a white reflective sheet was adhered to one surface. The backlight unit was fabricated by arranging an LED light source on the end surface on one side of the light guide plate 32 thus obtained, and the optical sheet 1 in a predetermined position on the light guide plate.

### Example 2

The optical sheet and the backlight unit of Example 2 were fabricated in the same manner as in Example 1 except that the apex angle shape of the unit prism 13 was changed. The apex angle shape of the unit prism had an interior angle θ of the apex constituting the ridge 14 of 68.0°, and a curved surface part with a radius of curvature (R) of 80 μm provided within a range of 10 μm from the tip. Such shapes were finely adjusted during groove processing using a diamond bit.

### Comparative Example 1

The heights of the arranged unit prisms 13 were made uniform without changing the ridge shape. Otherwise, the optical sheet and the backlight unit of Comparative Example 1 were fabricated in the same manner as in Example 1.

### Comparative Example 2

The optical sheet and the backlight unit of Comparative Example 2 were fabricated in the same manner as in Example 1 except that the resin composition for the unit prism was changed. As the resin composition for the unit prism, a resin composition including a mixed resin obtained by mixing pentaerythritol triacrylate hexamethylene diisocyanate/urethane prepolymer (manufactured by Kyoeisha Chemical Co., Ltd.) and ethyl methacrylate (manufactured by Kyoeisha Chemical Co., Ltd.) at a ratio of 4:6, and a photoinitiator (Irgacure 184, α-hydroxyalkylphenone, manufactured by BASF SE) was used.

### [Evaluation]

### (Measurement of Elastic Modulus)

The elastic modulus (physical property value representing difficulty of elasticity deformation) of the unit prism 13 of the optical sheet 1 was measured by a nanoindentation method using an ultramicro indentation hardness tester (product name: Nanoindentation Tester, model: ENT-1100a, manufactured by Elionix Inc.). As the indenter, a Berkovich-type indenter (quadrangular pyramidal indenter with a facing angle of 90°) was used. The test sample was sliced orthogonal to the extending direction X of the ridge 14 of the unit prism 13 by a microtome to a thickness of about 50 μm. The test sample was fixed on a measuring board with an adhesive so that the cross section thereof faced upward. Then, in accordance with ISO 14577-1, at a temperature of 20° C., the indenter was pressed while gradually applying the load to a 10-μm square area of the unit prism sample to a depth of 0 to 1 μm. After the sample was held for one second with a maximum load of 1 mN, the load value was measured while gradually raising the indenter to remove the load. From the load/unload measurement, the elastic modulus and the recovery rate were obtained. It should be noted that the nanoindentation method is a method for calculating the contact depth using the Oliver-Pharr analysis method on the unloading curved lines of the test force, and calculating the contact projected area from the contact depth.

The elastic modulus can be found from the relationship between the test force and the indentation depth of the indenter. Using the analysis software provided with the above-described nanoindentation tester, the slope of the straight line obtained from least squares fitting of the unload/indentation depth curved lines and the intersection point of the straight line with the indentation depth axis when the straight line with that slope is passed through the maximum load were found, and the calculation was conducted in accordance with ISO 14577-1 (A.5). At the time of calculation, the elastic modulus of the indenter was 1,200 GPa, and the Poisson's ratio of the indenter was 0.07.

The recovery rate is the percentage of the elastic reverse deformation work to the total work obtained from the relationship between the test force and the indentation depth generated by the test load expressed as a percentage. It should be noted that, although a portion of the total work by indentation of the indenter is consumed in the plastic deformation work, the rest is released as elastic reverse deformation work at the time of test loading and unloading. Like the elastic modulus, this recovery rate was also calculated using the provided analysis software. As the recovery rate increases, so does the shape recovery performance after deformation. Thus, samples with a high recovery rate also ultimately have excellent deformation resistance due to shape recovery.

The unit prism of Example 1 (the same as in Example 2 and Comparative Example 1) had an elastic modulus of 7.2 MPa and a recovery rate of 65%. On the other hand, the unit prism of Comparative Example 1 had an elastic modulus of 1.3 MPa and a recovery rate of 35%.

### (Measurement of Ridge Shape of Unit Prism)

The ridge shape of the unit prism 13 was observed by cutting the trough part 15 to the extent possible so that the cross section was parallel with the ridge 14, setting the unit prism 13 on a microscope so as to view the cutting cross section from the direction Y orthogonal to the extending direction X of the unit prism 13, and focusing the microscope on the ridge 14. In this measurement, the pitch was measured more accurately by measuring the amplitude and the highest portion of the ridge using the interface between the base material 11 and the prism part 12 as a reference plane.

The measurement results showed that the ridge shape of Example 1 was such that the difference between the maximum height h1 and the minimum height h2 in the extending direction X of the ridge 14 was 4 μm, and this was repeated at a pitch (interval) of 1 mm. The ridge shape of Comparative Example 1 was such that the height was constant (within ±0.1 μm).

### (Wet-Out Evaluation)

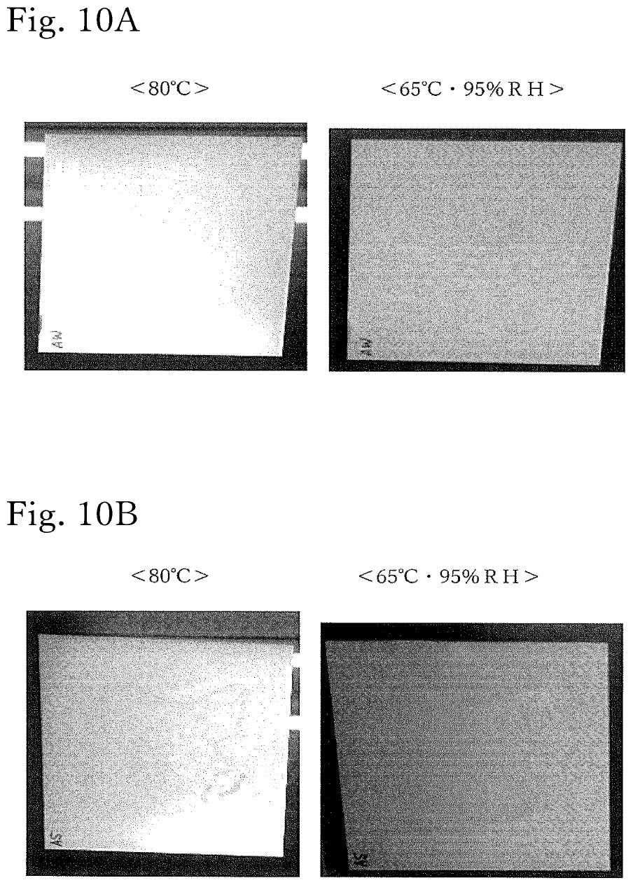

A polycarbonate resin plate for a light guide plate having a 0.5-mm thickness and cut to a 150-mm length and a 150-mm width was placed on a glass plate having a 500-g weight, a 300-mm length, a 300-mm width, and a 1-mm thickness. The optical sheet 1 obtained in Examples 1 and 2 and Comparative Examples 1 and 2 and cut to a 100-mm length and a 100-mm width was placed with the ridge 14 of the unit prism 13 downward on the polycarbonate resin plate, and a glass plate having a 500-g weight, a 150-mm length, a 150-mm width, and a 9-mm thickness was further placed on the optical sheet 1. At this time, the load applied to the optical sheet 1 was 500 gf, which was a load of 5 g/cm² per unit area. In such a state, the sample was left to stand in an oven at 80° C. and in an oven at 65° C. and 95% RH for 72 hours, respectively, and then, upon removal, visually evaluated for the presence or absence of the wet-out 19. The results are shown in the images of FIGS. 10A and 10B.

When the optical sheets of Examples 1 and 2 were used, the wet-out 19 did not occur, as illustrated in FIG. 10A, but when the optical sheets of Comparative Examples 1 and 2 were used, the wet-out 19 occurred as illustrated in FIG. 10B. Further, upon removing the optical sheet after testing and visually observing the surface of the light guide plate, damage was noticeable on the surface of the light guide plate when using the optical sheets of Comparative Examples 1 and 2 upon comparison to the cases where the optical sheets of Examples 1 and 2 are used.

### DESCRIPTIONS OF REFERENCE NUMERALS

1 Optical sheet
11 Base material
12 Prism part
13 Unit prism 14 Ridge (Ridge part)
15 Trough (Trough part)
17 Light transmission and diffusion layer
19 Wet-out
21, 22 Prism surface
30 Backlight unit
32 Light guide plate
32A Side end surface
32B Light emitting surface
34 Light source
36 Reflector
50 Liquid crystal display device
52 Liquid crystal panel
S1 One surface of base material
S2 Other surface of base material
X Linearly extending direction of unit prism (Extending direction of ridge)
Y Arrangement direction of unit prism (Direction intersecting ridge)
Z Thickness direction of optical sheet
h Ridge height of unit prism (Height from surface of base material)
h1 Maximum height of ridge
h2 Minimum height of ridge
h′ Height of unit prism (Height from trough to ridge)
θ Interior angle of unit prism apex part
L1, L2 Curved surface shaped region
R1, R2 Radius of curvature of curved shape region
S1 Base material surface on prism part side
S2 Base material surface on side opposite to prism part

1. An optical sheet comprising:
a plurality of unit prisms disposed in parallel, wherein
the unit prism has an elastic modulus within a range of 0.5 MPa to 10 MPa, inclusive, and a height of a ridge of the unit prism that changes in an extending direction of the ridge or differs between unit prisms adjacent to each other.

2. The optical sheet according to claim 1, wherein
the ridge has a linear shape, a polyline shape, or a curved shape, in a planar view.

3. The optical sheet according to claim 1, wherein
a height of the unit prism of the ridge in the extending direction changes within a range of 0.5 μm to 15 μm, inclusive, at an interval within a range of 0.005 mm to 5 mm, inclusive.

4. The optical sheet according to claim 1, wherein
the unit prism has a recovery rate within a range of 50% to 100%, inclusive.

5. A backlight unit comprising at least:
the optical sheet described in claim 1;
a light guide plate; and
a light source, wherein
the unit prism constituting the optical sheet is disposed facing a surface of the light guide plate.

6. The backlight unit according to claim 5, wherein the light guide plate is at least one selected from the group consisting of an acrylic resin, a polycarbonate resin, and glass.

7. The optical sheet according to claim 2, wherein
a height of the unit prism of the ridge in the extending direction changes within a range of 0.5 μm to 15 μm, inclusive, at an interval within a range of 0.005 mm to 5 mm, inclusive.

8. The optical sheet according to claim 2, wherein
the unit prism has a recovery rate within a range of 50% to 100%, inclusive.

9. A backlight unit comprising at least:
the optical sheet described in claim 2;
a light guide plate; and
a light source, wherein
the unit prism constituting the optical sheet is disposed facing a surface of the light guide plate.

10. The backlight unit according to claim 9, wherein the light guide plate is at least one selected from the group consisting of an acrylic resin, a polycarbonate resin, and glass.

11. The optical sheet according to claim 3, wherein
the unit prism has a recovery rate within a range of 50% to 100%, inclusive.

12. A backlight unit comprising at least:
the optical sheet described in claim 3;
a light guide plate; and
a light source, wherein
the unit prism constituting the optical sheet is disposed facing a surface of the light guide plate.

13. The backlight unit according to claim 12, wherein the light guide plate is at least one selected from the group consisting of an acrylic resin, a polycarbonate resin, and glass.

14. The optical sheet according to claim 7, wherein
the unit prism has a recovery rate within a range of 50% to 100%, inclusive.

15. A backlight unit comprising at least:
the optical sheet described in claim 7;
a light guide plate; and
a light source, wherein
the unit prism constituting the optical sheet is disposed facing a surface of the light guide plate.

16. The backlight unit according to claim 15, wherein the light guide plate is at least one selected from the group consisting of an acrylic resin, a polycarbonate resin, and glass.

17. A backlight unit comprising at least:
the optical sheet described in claim 4;
a light guide plate; and
a light source, wherein
the unit prism constituting the optical sheet is disposed facing a surface of the light guide plate.

18. The backlight unit according to claim 17, wherein the light guide plate is at least one selected from the group consisting of an acrylic resin, a polycarbonate resin, and glass.

19. A backlight unit comprising at least:
the optical sheet described in claim 14;
a light guide plate; and
a light source, wherein
the unit prism constituting the optical sheet is disposed facing a surface of the light guide plate.

20. The backlight unit according to claim 19, wherein the light guide plate is at least one selected from the group consisting of an acrylic resin, a polycarbonate resin, and glass.
